(19) United States
(12) Patent Application Publication
(10) Pub. No.: US 2026/0131726 A1
(43) Pub. Date: May 14, 2026

(54) NOTIFICATION CONTROL DEVICE, NOTIFICATION CONTROL METHOD, AND STORAGE MEDIUM

(71) Applicant: HONDA MOTOR CO., LTD., Tokyo (JP)

(72) Inventors: Hirotaka Katayama, Tokyo (JP); Yuichi Masukake, Wako-shi (JP); Kazuma Hamada, Tokyo (JP)

(21) Appl. No.: 19/381,028

(22) Filed: Nov. 6, 2025

(30) Foreign Application Priority Data
Nov. 14, 2024 (JP) 2024-199243

(51) Int. Cl. B60Q 9/00; G06F 3/01

(52) U.S. Cl. CPC B60Q 9/00; G06F 3/011

(57) ABSTRACT

According to an embodiment, a notification control device includes a monitoring direction recognizer configured to recognize a monitoring direction of a driver of a mobile object, a determiner configured to determine whether or not the monitoring direction recognized by the monitoring direction recognizer is appropriate, and a notification controller configured to control a notification for the driver in accordance with a determination result of the determiner. The notification controller facilitates an end of the notification when recognition accuracy of the monitoring direction in the monitoring direction recognizer decreases during the notification.

### CROSS-REFERENCE TO RELATED APPLICATION

Priority is claimed on Japanese Patent Application No. 2024-199243, filed November 14, 2024, the content of which is incorporated herein by reference.

### BACKGROUND

### Field of the Invention

The present invention relates to a notification control device, a notification control method, and a storage medium.

### Description of the Related Art

Recently, efforts to provide access to sustainable transportation systems have been increasingly active in consideration of vulnerable individuals among participants in transportation. For this realization, research and development efforts are focused on further improving the safety and convenience of transportation through research and development related to preventive safety technology. In this regard, conventional technology for recognizing a driver’s gaze or face orientation using an image captured by a driver camera and providing assistance for the driver when distracted driving is determined from a recognition result is known (for example, Japanese Unexamined Patent Application, First Publication No. 2019-91281).

### SUMMARY

Meanwhile, in conventional preventive safety technologies, because the recognition accuracy of a monitoring direction of a driver recognized from images or the like changes with a change or the like in a surrounding situation of the moving object, there is a possibility that the driver’s state, such as distraction, cannot be appropriately determined. Therefore, there is a problem because there is a possibility that a notification for the distraction cannot be appropriately controlled.

The present application has been made in consideration of such circumstances and an objective of the present application is to provide a notification control device, a notification control method, and a storage medium that can enable a notification to be more appropriately provided for a driver. Also, the present invention contributes to the development of a sustainable transportation system.

A notification control device, a notification control method, and a storage medium according to the present invention adopt the following configurations.

(1): According to an aspect of the present invention, there is provided a notification control device including: a monitoring direction recognizer configured to recognize a monitoring direction of a driver of a mobile object; a determiner configured to determine whether or not the monitoring direction recognized by the monitoring direction recognizer is appropriate; and a notification controller configured to control a notification for the driver in accordance with a determination result of the determiner, wherein the notification controller facilitates an end of the notification when recognition accuracy of the monitoring direction in the monitoring direction recognizer decreases during the notification.

(2): In the above-described aspect (1), the notification controller ends the notification regardless of a result of determining whether or not the monitoring direction is appropriate in the determiner when the recognition accuracy of the monitoring direction decreases during the notification.

(3): In the above-described aspect (1), the monitoring direction recognizer recognizes the monitoring direction using at least one of eye movement and face movement of the driver, and, when it is determined that the monitoring direction of the driver recognized based on at least the eye movement by the monitoring direction recognizer is inappropriate and the recognition accuracy of the monitoring direction decreases during the notification by the notification controller, the determiner determines whether or not the monitoring direction of the driver is appropriate according to the monitoring direction recognized based on the face movement of the driver without using the eye movement.

(4): In the above-described aspect (1), the notification controller starts the notification for the driver when the determiner determines that the monitoring direction recognized based on at least the face movement of the driver by the monitoring direction recognizer is inappropriate, and the notification controller facilitates the end of the notification when the recognition accuracy of the monitoring direction in the monitoring direction recognizer decreases during the notification.

(5): In the above-described aspect (1), the notification controller performs a counting process for a period of time in which it is determined that the monitoring direction is appropriate when the determiner determines that the monitoring direction of the driver is an appropriate monitoring direction during the notification and ends the notification when the appropriate monitoring direction continues for a predetermined time or more, and the notification controller continues the counting process when it is determined that the recognition accuracy of the monitoring direction of the driver decreases while the period of time in which it is determined that the monitoring direction recognized based on the eye movement and the face movement of the driver is an appropriate monitoring direction is counted and when it is determined that the monitoring direction recognized based on a face orientation of the driver is an appropriate monitoring direction.

(6): According to another aspect of the present invention, there is provided a notification control method including: recognizing, by a computer, a monitoring direction of a driver of a mobile object; determining, by the computer, whether or not the recognized monitoring direction is appropriate; controlling, by the computer, a notification for the driver in accordance with a determination result; and facilitating, by the computer, an end of the notification when recognition accuracy of the monitoring direction decreases during the notification.

(7): According to yet another aspect of the present invention, there is provided a computer-readable non-transitory storage medium storing a program for causing a computer to: recognize a monitoring direction of a driver of a mobile object; determine whether or not the recognized monitoring direction is appropriate; control a notification for the driver in accordance with a determination result; and facilitate an end of the notification when recognition accuracy of the monitoring direction decreases during the notification.

According to the above-described aspects (1) to (7), it is possible to more appropriately provide a notification for a driver.

### BRIEF DESCRIPTION OF THE DRAWINGS

FIG. 1 is a configuration diagram of a vehicle system including a notification control device according to an embodiment.

FIG. 2 is a diagram showing a relationship between a monitoring direction of a driver and a monitoring target area.

FIG. 3 is a flowchart showing an example of a process executed by a driving assistance device in the embodiment.

### DESCRIPTION OF EMBODIMENTS

Hereinafter, embodiments of a notification control device, a notification control method, and a storage medium of the present invention will be described with reference to the drawings. Hereinafter, an example of a mobile object to which the notification control device is applied will be described. It is assumed that an example of the mobile object is a vehicle. In addition to the vehicle, the mobile object may include, for example, a watercraft that can move on the ground (on the road) like a hovercraft, an aircraft that can travel on the road, a stand-up vehicle having a motive power unit, micromobility such as an electric scooter, and the like.

### Overall configuration

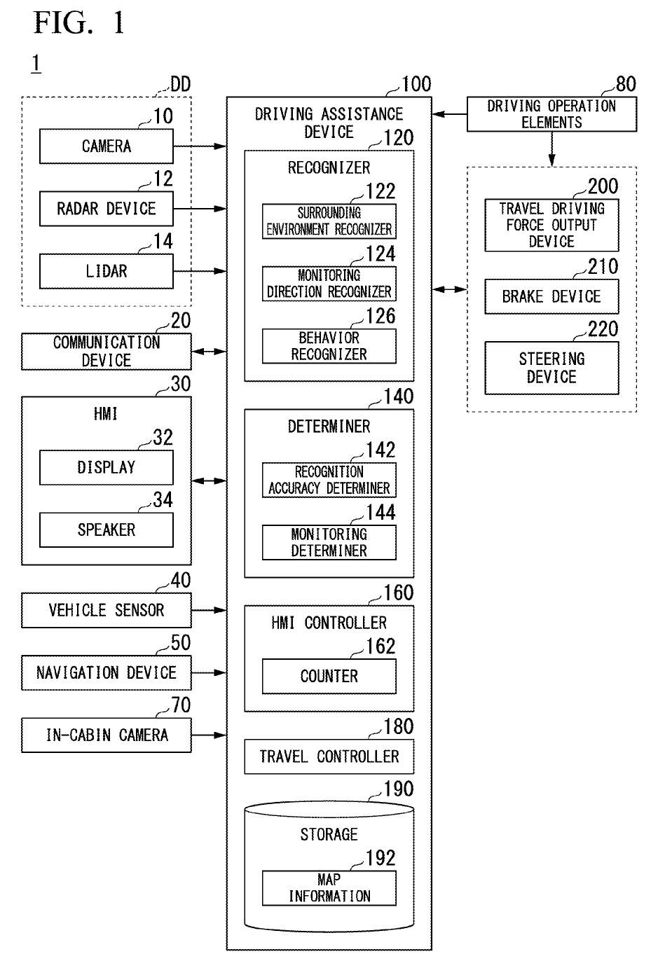

FIG. 1 is a configuration diagram of a vehicle system 1 including the notification control device according to the present embodiment. A vehicle (hereinafter referred to as a vehicle M) in which the vehicle system 1 is mounted is, for example, a micromobility or a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a battery (a power storage battery) such as a secondary battery or a fuel cell is discharged.

For example, the vehicle system 1 includes a camera 10, a radar device 12, a light detection and ranging (LIDAR) 14, a communication device 20, a human machine interface (HMI) 30, a vehicle sensor 40, a navigation device 50, an in-cabin camera 70, driving operation elements 80, a driving assistance device 100, a travel driving force output device 200, a brake device 210, and a steering device 220. Such devices and equipment are connected to each other by a multiplex communication line such as a controller area network (CAN) communication line, a serial communication line, a wireless communication network, or the like. The configuration shown in FIG. 1 is merely an example and some of the constituent elements may be omitted or other constituent elements may be further added. The camera 10, the radar device 12, and the LIDAR 14 are examples of a “detection device DD.” The HMI 30 is an example of a “notifier.” The HMI 30 and the driving assistance device 100 are examples of a “notification control device.”

For example, the camera 10 is a digital camera using a solid-state imaging element such as a charge-coupled device (CCD) or a complementary metal oxide semiconductor (CMOS). The camera 10 is attached to any location on the vehicle M on which the vehicle system 1 is mounted. When the view in front of the vehicle M is imaged, the camera 10 is attached to an upper part of a front windshield, a rear surface of a rearview mirror, a front part of a vehicle body, or the like. When the view to the rear of the vehicle M is imaged, the camera 10 is attached to an upper part of a rear windshield, a back door, or the like. When the views to the sides of the vehicle M are imaged, the camera 10 is attached to left and right door mirrors or the like. For example, the camera 10 periodically and iteratively images the surroundings of the vehicle M. The camera 10 may be a stereo camera.

The radar device 12 radiates radio waves (radar) such as millimeter waves around the vehicle M and detects at least a position of a physical object (a distance from the physical object and a direction of the physical object) by detecting radio waves (reflected waves) reflected by the physical object near the vehicle M. The radar device 12 is attached to any location on the vehicle M. The radar device 12 may detect a position and a speed of the physical object in a frequency-modulated continuous wave (FM-CW) scheme.

The LIDAR 14 radiates light to the vicinity of the vehicle M and measures scattered light. The LIDAR 14 detects a distance from an object on the basis of time from light emission to light reception. The radiated light is, for example, pulsed laser light. The LIDAR 14 is attached to any location on the vehicle M.

The communication device 20, for example, communicates with another vehicle located in the vicinity of the vehicle M, a terminal device of a user using the vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the vehicle M and receives input operations from the occupants. The HMI 30 includes, for example, a display 32 and a speaker 34. The display 32 is, for example, a liquid crystal display (LCD), an electro-luminescence (EL) display device, or the like. The display 32 displays various types of images (including videos) in the embodiment. The display 32 may be configured to be integrated with an input as a touch panel. The speaker 34 outputs a predetermined sound (e.g., a notification sound, a message sound, or the like). The HMI 30 may include microphones, buzzers, touch panels, switches, keys, and the like. The switches may include, for example, a switch for executing or ending predetermined driving control or the like executable by a travel controller to be described below, a switch for approving (permitting) or rejecting a driving control recommendation (proposal) from a system (vehicle system 1) side, and the like. The switches may include a switch (turn signal switch) for performing a direction indication operation and the like.

The vehicle sensor 40 includes a vehicle speed sensor configured to detect the speed of the vehicle M, an acceleration sensor configured to detect acceleration, and a yaw rate sensor configured to detect a yaw rate (e.g., a rotational angular velocity around a vertical axis passing through the center of gravity of the vehicle M). The vehicle sensor 40 may include a lateral acceleration sensor (lateral G sensor) that detects the lateral acceleration (lateral G) of the vehicle M, a steering angle sensor that detects a steering angle of the vehicle M (which may be an angle of the steering wheel or an operation angle of the steering wheel), a steering angular velocity sensor that detects a steering angular velocity, a direction sensor that detects an orientation of the vehicle M, and the like.

The vehicle sensor 40 may include a position sensor configured to detect the position of the vehicle M. The position sensor is, for example, a sensor configured to acquire position information (longitude/latitude information) from a Global Positioning System (GPS) device. For example, the position sensor may be a sensor configured to acquire position information using a global navigation satellite system (GNSS) receiver of the navigation device 50. The vehicle sensor 40 may derive the speed of the vehicle M from a position information difference (i.e., a distance) at a predetermined time in the position sensor. A detection result of the vehicle sensor 40 is output to the driving assistance device 100.

For example, the navigation device 50 includes the GNSS receiver, a navigation HMI, and a route decider. The navigation device 50 may store map information in a storage device such as a hard disk drive (HDD) or a flash memory or may acquire map information 192 stored in the storage 190 to be described below. The GNSS receiver identifies a position of the vehicle M on the basis of a signal received from a GNSS satellite. The position of the vehicle M may be identified or complemented by an inertial navigation system (INS) using an output of the vehicle sensor 40. The navigation HMI includes a display device, a speaker, a touch panel, a key, and the like. The GNSS receiver may be provided in the vehicle sensor 40. The navigation HMI may be partly or wholly shared with the above-described HMI 30. For example, the route decider decides a route (hereinafter referred to as a route on a map) from the position of the vehicle M identified by the GNSS receiver (or any input position) to a destination input by the occupant using, for example, the navigation HMI with reference to the map information 192 or the like. The navigation device 50 provides route guidance using the navigation HMI based on the decided route on the map. The navigation device 50 may transmit a current position and a destination to a navigation server via the communication device 20 and acquire a route equivalent to the route on the map from the navigation server.

Here, the map information 192 is, for example, information in which a road shape is expressed by a link indicating a road (an example of a movement path) and nodes connected by the link. The map information 192 may include point of interest (POI) information, and the like. The map information 192 includes, for example, the number of lanes (the number of movement paths), a type and shape of a road marking, information about a center of a lane or information about a road boundary, and the like. The map information 192 may include information about whether the road boundary is a boundary (physical boundary) including a structure through which the vehicle cannot pass (including crossing or contacting). Physical boundaries are, for example, guardrails, curbs, medians, fences, and the like. The map information 192 may include road shape information, traffic regulation information, address information (address and postal code), facility information, parking lot information, phone number information, and the like. The road shape information is information such as the curvature of the road (which may also be expressed as a radius of curvature, and the same applies hereinafter), a width, a road surface gradient, and information about branch points, merging points, intersections, T-junctions, and the like. The map information 192 may include information about structures around roads, information indicating a location (segment) of a tunnel, and information indicating a location (segment) of a road passing under a bridge or an overpass. The map information 192 may be updated from time to time when the communication device 20 communicates with an external device.

The in-cabin camera 70, for example, is a digital camera using a solid-state image sensor such as a CCD and CMOS. The in-cabin camera 70 is mounted at any location in the vehicle M in a position and orientation that allow the head of the driver sitting in the driver’s seat of the vehicle M to be imaged from the front. For example, the in-cabin camera 70 is mounted (e.g., an upper portion or a lower portion) near the display device located in the center of the instrument panel of the vehicle M. The in-cabin camera 70 may image the interior of the vehicle in the area including the occupant (passenger) sitting in a passenger seat of the vehicle M or the like other than the driver. The in-cabin camera 70 can also image a cabin by radiating infrared light towards the cabin. The in-cabin camera 70, for example, periodically and iteratively images the cabin.

The driving operation elements 80 include, for example, a steering wheel, an accelerator pedal, and a brake pedal. The driving operation elements 80 may also include a shift lever, a variant steering wheel, a joystick, and other operation elements. For example, an operation detector configured to detect an amount of operation on the operation element by the driver or the presence or absence of operation is attached to each operation element of the driving operation elements 80. The operation detector detects, for example, a steering angle and steering torque of the steering wheel (e.g., an amount of steering based on a driving operation of the driver (steering input torque)), a steering torque variation rate, amounts of depression of the accelerator pedal and the brake pedal, and the like. Also, the operation detector outputs the detection result to the driving assistance device 100 or some or all of the travel driving force output device 200, the brake device 210, and the steering device 220. Also, the operation detector outputs the detection result to the driving assistance device 100, or to one or all of the travel driving force output device 200, the brake device 210, and the steering device 220. The driving operation element 80 may include a direction indication operator (e.g., a turn signal lever or a turn signal switch). When the direction indication operator has been operated, a turn signal (direction indicator) of the vehicle M associated with the operation content blinks, and the operation content (e.g., including a result of detecting an operation performed by the driver) is output to the driving assistance device 100.

The driving assistance device 100 executes various types of driving control for supporting the driving of the driver of the vehicle M. The driving assistance device 100 includes, for example, a recognizer 120, a determiner 140, an HMI controller 160, a travel controller 180, and a storage 190. Each of the recognizer 120, the determiner 140, the HMI controller 160, and the travel controller 180 is implemented, for example, by a hardware processor such as a central processing unit (CPU) executing a program (software). Some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as an HDD or a flash memory of the driving assistance device 100 or may be stored in a removable storage medium such as a DVD, a CD-ROM, or a memory card and installed in the storage device of the driving assistance device 100 when the storage medium (the non-transitory storage medium) is mounted on a drive device, a card slot, or the like. The travel controller 180 is an example of a “movement controller.” The HMI controller 160 is an example of a “notification controller.”

The storage 190 may be implemented by the above-described various storage devices, an electrically erasable programmable read-only memory (EEPROM), a read-only memory (ROM), a random-access memory (RAM), or the like. The storage 190 stores, for example, the map information 192, various information in embodiments, programs, and the like. The storage 190 may store various types of setting information for use in the process in the present embodiment.

The recognizer 120, for example, includes a surrounding environment recognizer 122, a monitoring direction recognizer 124, and a behavior recognizer 126. The surrounding environment recognizer 122 recognizes a surrounding situation of the vehicle M, for example, based on a detection result of the detection device DD (information input from the camera 10, the radar device 12, and the LIDAR 14). For example, the surrounding environment recognizer 122 performs a sensor fusion process on some or all of the detection results of the camera 10, the radar device 12, and the LIDAR 14 to recognize states of the position (relative position), size, speed (relative speed), acceleration, and the like of a physical object located in the vicinity of the vehicle M (within a predetermined distance). Physical objects recognized by the surrounding environment recognizer 122 may include, for example, traffic participants (examples of obstacles) such as other vehicles, pedestrians, bicycles, and the like in addition to physical boundaries that divide the road (movement path). The position of the physical object, for example, is recognized as a position on absolute coordinates with a representative point (the center of gravity, the center of drive shaft, or the like) of the vehicle M as the origin, and is used for control. The position of the physical object may be indicated by a representative point such as the center of gravity or a corner of the physical object or may be indicated by an area that has been represented. The “state” of the physical object may include, for example, the acceleration or jerk of another vehicle, or the “action state” (e.g., whether or not the other vehicle is changing lanes or is about to change lanes) when the physical object is the other vehicle.

The surrounding environment recognizer 122 may recognize, for example, a stop line, a red light, a toll booth, other road events, road signs, and markings drawn on the road (e.g., speed limits), and the like. The surrounding environment recognizer 122 may recognize the curvature of a travel lane (travel road) of the vehicle M based on the detection results of the detection device DD or the map information 192. The surrounding environment recognizer 122 may recognize a road surface situation (e.g., whether the road surface is slippery, such as freezing of the road surface) and the like based on the detection result of the detection device DD.

The surrounding environment recognizer 122 recognizes, for example, a lane in which the vehicle M is traveling (travel lane), other lanes located in a nearby area (e.g., adjacent lanes), and the like. For example, the surrounding environment recognizer 122 recognizes a road marking from the image captured by the camera 10, and recognizes the travel lane and other lanes based on a positional relationship of the recognized road markings seen from the vehicle M. The surrounding environment recognizer 122 may recognize the lane in which the vehicle M is traveling or other lanes with reference to the map information 192 based on the position information of the vehicle M obtained from the vehicle sensor 40 and the like. The surrounding environment recognizer 122 may recognize structures such as tunnels, overpasses, and viaducts and structures near roads.

The monitoring direction recognizer 124 recognizes a state of an occupant of the vehicle M using an image captured by the in-cabin camera 70. For example, the monitoring direction recognizer 124 performs a known image analysis process (e.g., a process for extracting feature quantities of an edge, a shape, a size, and a color, a matching process such as pattern matching, or the like) on an image captured by the in-cabin camera 70, and recognizes a monitoring direction of the driver of the vehicle M based on the image analysis result. For example, the monitoring direction recognizer 124 recognizes the monitoring direction using at least one of the driver's eye movement and face movement obtained from the image analysis result. The eye movement is, for example, the gaze (a direction in which the driver is looking). The face movement is, for example, an orientation of the face.

For example, the monitoring direction recognizer 124 detects a combination of the driver’s eye reference point (a part where the eye does not move) and a moving point (a moving part of the eye) from the captured image using a method such as pattern matching. The combination of the reference point and the moving point is, for example, a combination of the inner canthus of the eye and the iris, a combination of the corneal reflection area and the pupil, or the like. The corneal reflection area is an area of reflection of infrared light in the cornea, for example, when the in-cabin camera 70 radiates infrared light towards the driver. Also, the monitoring direction recognizer 124 recognizes the driver’s gaze by performing coordinate conversion from an image plane into an actual space and the like based on the position of the moving point relative to the reference point.

The monitoring direction recognizer 124 recognizes the driver’s face orientation based on position information (such as relative position information for each part) of the eyes, nose, mouth, and the like within a facial area obtained from a result of analyzing the captured image.

When the monitoring direction recognizer 124 is able to recognize the driver’s gaze and face orientation, the monitoring direction is recognized using both the gaze and face orientation. Thereby, it is possible to recognize the monitoring direction more accurately. When the monitoring direction recognizer 124 recognizes only one of the gaze and face orientation, the monitoring direction is recognized using the one of the gaze and face orientation.

The monitoring direction recognizer 124 may also use template matching or other methods to recognize whether the driver is wearing sunglasses, glasses, a mask, or the like from a result of analyzing the image from the in-cabin camera 70. In this case, the monitoring direction recognizer 124 recognizes the monitoring direction based on only the face orientation when the driver is wearing sunglasses or glasses and recognizes the monitoring direction based on only the gaze because a feature part such as the nose or mouth cannot be recognized from the image and the recognition accuracy of the face orientation decreases when the driver is wearing a mask.

In the recognition of information using the images described above, for example, a trained model previously trained by machine learning or the like may be used. In this case, the monitoring direction recognizer 124 inputs the image captured by the in-cabin camera 70 to a trained model that takes an image as input and outputs the monitoring direction of a person included in the image (e.g., a gaze or face orientation), and acquires the driver’s monitoring direction. The monitoring direction recognizer 124 may also recognize the monitoring direction using other known methods.

The recognition result of the monitoring direction recognizer 124 may include information indicating whether the monitoring direction has been recognized based on the driver’s eye movement (e.g., gaze), whether the monitoring direction has been recognized the driver’s face movement (e.g., face orientation), or whether the monitoring direction has been recognized using both the eye movement and the face movement. The recognition result may include information indicating whether the driver’s eye movement has been recognized from one eye or both eyes of the driver or may include information indicating that eye movement or face movement has not been recognized.

The behavior recognizer 126 recognizes the behavior of the vehicle M based on the detection result of the vehicle sensor 40 and content of control executed by the travel controller 180. The behavior of the vehicle M includes a behavior resulting from manual driving by the driver and a behavior resulting from driving control executed by the travel controller 180.

For example, the behavior recognizer 126 recognizes a lateral position of the vehicle M relative to the travel lane (a position in the lane width direction) and a posture (orientation) of the vehicle M relative to an extension direction of the travel lane based on a positional relationship of the vehicle M relative to the travel lane. For example, the behavior recognizer 126 may recognize a deviation of a reference point of the vehicle M from the center of the lane and an angle formed between the travel direction of the vehicle M and a line connected to the center of the lane as a relative position and orientation of the vehicle M related to the travel lane. Alternatively, the behavior recognizer 126 may recognize a position of the reference point of the vehicle M related to one side end portion (a road marking or a road boundary) of the travel lane or the like as a relative position (lateral position) of the vehicle M related to the travel lane. The behavior recognizer 126 may recognize the lateral behavior of the vehicle M (e.g., whether or not there has been lateral movement of a predetermined distance or more at a given time) from an amount of change in the lateral position of the vehicle M and the direction (yaw rate) of the vehicle M described above or may recognize that the behavior is disturbed when the amount of change is greater than or equal to a predetermined amount.

When the vehicle M is being manually driven, the behavior recognizer 126 detects the behavior of the vehicle M from an amount of steering wheel operation (e.g., steering angle, steering torque, steering torque change rate), depression amounts of the accelerator pedal and brake pedal, and the like obtained by the operation detector, or recognizes an amount of change in behavior for a predetermined time.

The behavior recognizer 126 may recognize the behavior of the vehicle M based on the content of the driving control executed by the travel controller 180. The driving control is control for causing the vehicle M to travel by controlling at least one of the steering and the speed of the vehicle M, regardless of the driver’s driving operation from the driver or by receiving only a partial operation instruction. Driving control includes, for example, an adaptive cruise control system (ACC), a lane keeping assistance system (LKAS), auto lane changing (ALC), and the like. The driving control may include control for stopping the vehicle M at a safe location such as a shoulder and control for controlling steering or speed to avoid contact between the vehicle M and an obstacle recognized by the surrounding environment recognizer 122. For example, the behavior recognizer 126 recognizes the behavior of the vehicle M by the execution of a driving controller for LKAS, ALC, or the like by the travel controller 180.

The determiner 140 includes, for example, a recognition accuracy determiner 142 and a monitoring determiner 144. The recognition accuracy determiner 142 determines whether or not the accuracy (recognition accuracy) of a result of recognizing the driver’s monitoring direction recognized by the monitoring direction recognizer 124 has decreased. The recognition accuracy is, for example, an index value indicating a degree to which the monitoring direction of the monitoring driver is correctly recognized from the image captured by the in-cabin camera 70. Low recognition accuracy means, for example, that there is a high possibility that the driver’s monitoring direction will not be correctly recognized from the image captured by the in-cabin camera 70 or that the driver’s monitoring direction is not correctly recognized (or may include the fact that the monitoring direction itself is not recognized).

The monitoring determiner 144 determines whether or not the driver’s monitoring direction is appropriate, for example, based on the monitoring direction recognized by the monitoring direction recognizer 124 and a preset monitoring target area. The functions of the recognition accuracy determiner 142 and the monitoring determiner 144 will be described in detail below.

The HMI controller 160 notifies occupants (including the driver) of predetermined information using the HMI 30 or receives information input by the HMI 30. The predetermined information includes, for example, information related to the travel of the vehicle M, such as information about the state of the vehicle M and information about the driving control. The information about the state of the vehicle M includes, for example, the vehicle M’s speed, engine speed, and shift position and the like. The information about the driving control includes, for example, whether or not the driving control has been executed by the travel controller 180, information about an execution situation of the driving control, information about the recommendation (proposal) of the driving control from the system side, notification information (an alert or the like) for the driver, and the like. The predetermined information may include information about the surrounding situation recognized by the detection device DD. The predetermined information may include information that is not related to the travel of the vehicle M, such as TV programs and content (e.g., videos) stored in storage media such as DVDs. The predetermined information may include, for example, information about a current position and destination of the vehicle M, and the remaining fuel level of the vehicle M. The HMI controller 160 may output information received by the HMI 30 to the communication device 20, the navigation device 50, the recognizer 120, the determiner 140, the travel controller 180, or the like.

The HMI controller 160 may generate inquiry information or recommendation information for the occupant, the recognition result of the recognizer 120, the determination result of the determiner 140, notification information, and the like and output the generated information to the HMI 30. The generated information includes images and sounds (including notification sounds and the like). The HMI controller 160 may transmit various types of information output by the HMI 30 to a terminal device used by the occupant of the vehicle M via the communication device 20.

The HMI controller 160 includes a counter 162. For example, when the occupant (the driver or the like) of the vehicle M is notified of predetermined notification information via the HMI 30, the counter 162 performs a counting process for a period from the time when a notification condition is satisfied to the time when the notification actually starts or performs a counting process for a period from the time when the notification starts to the time when the notification stops (ends). When the driver’s monitoring direction becomes an appropriate monitoring direction while the notification information is being provided, the counter 162 may perform a counting process for the duration of this monitoring direction.

The travel controller 180 controls the driving of the vehicle M. For example, the travel controller 180 executes driving control for the vehicle M based on a recognition result of the recognizer 120 and a determination result of the determiner 140. The driving control may be executed by receiving an instruction from the driver via the HMI 30 or may be executed independently of the driver’s instruction based on the recognition result of the recognizer 120. When the driving control is executed, the travel controller 180 generates a future target trajectory of the vehicle M according to the content of the driving control based on the recognition result of the recognizer 120, and controls at least one of the steering and speed of the vehicle M so that the vehicle M travels according to the generated target trajectory.

For example, the travel controller 180 performs driving control such as ACC, LKAS, or ALC. The travel controller 180 may perform a process for controlling the vehicle M so that the vehicle M stops at a safe position such as the shoulder of the road or the like or a control process for avoiding contact between the obstacle and the vehicle M when the driver’s monitoring direction has not improved even after the elapse of a predetermined time or more from the output of alert information indicating that the driver’s monitoring direction is inappropriate or the like by the HMI controller 160.

The travel driving force output device 200 outputs a travel driving force (torque) for enabling the vehicle to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the travel controller 180 or information input from the accelerator pedal of the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the travel controller 180 or the information input from the brake pedal of the driving operation element 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the travel controller 180 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the travel controller 180 or the information input from the steering wheel of the driving operation element 80 to change the direction of the steerable wheels.

### Recognition accuracy determiner and monitoring determiner

Next, functions of the recognition accuracy determiner 142 and the monitoring determiner 144 will be described in detail. Hereinafter, it is assumed that the driver’s gaze is used as an example of the driver’s eye movement and the driver’s face orientation is used as an example of the driver’s face movement. For example, when the monitoring direction cannot be recognized from the driver’s gaze based on the recognition result of the monitoring direction recognizer 124, the recognition accuracy determiner 142 determines that the recognition accuracy of the monitoring direction has decreased, regardless of whether or not the monitoring direction can be recognized from the driver’s face orientation.

The recognition accuracy determiner 142 may also determine that the recognition accuracy of the monitoring direction has decreased when it is determined that the image has been affected by external disturbances based on an image analysis result of images captured by the in-cabin camera 70. For example, the recognition accuracy determiner 142 determines that the recognition accuracy has decreased when an amount of change in a luminance value of the captured image during a predetermined period of time is greater than or equal to a predetermined amount and determines that the recognition accuracy has not decreased if the amount of change is less than the predetermined amount. The luminance value of the captured image may be an average luminance value of the entire image or an average luminance value of the driver’s face area extracted by an edge extraction process on the captured image. For example, when vehicle M is traveling near the entrance or exit of a tunnel or when the luminance value of the image changes suddenly due to external disturbances such as shadows from structures around the road, sunlight shining into the vehicle cabin, or the headlights of oncoming vehicles, there is a high possibility that the driver’s gaze and face orientation cannot be accurately recognized through image analysis. Therefore, regardless of the recognition result of the monitoring direction recognizer 124, the recognition accuracy determiner 142 determines that the recognition accuracy has decreased due to an influence of external disturbances when the amount of change in the luminance value of the image captured by the in-cabin camera 70 (the amount of change over a predetermined time period) is greater than or equal to a predetermined amount.

The recognition accuracy determiner 142 may refer to the map information 192 based on the position information of the vehicle M detected by the vehicle sensor 40, and may determine that the recognition accuracy of the monitoring direction has decreased when the vehicle M’s position is within a predetermined distance from a place estimated to be susceptible to external disturbances, such as a tunnel, a bridge, or an underpass. If an exposure control function of controlling the amount of light in accordance with the luminance of an image capture area is provided in the in-cabin camera 70, the recognition accuracy determiner 142 may determine whether or not the recognition accuracy has decreased based on parameters of the exposure control function (e.g., an exposure-control-specific pulse width modulation (PWM) value, a shutter opening degree, a shutter speed, and an exposure time) and the like.

When it is determined that the driver is wearing sunglasses, glasses, or the like based on the results of image analysis of the captured image, the recognition accuracy determiner 142 may determine that the recognition accuracy of the monitoring direction has decreased because there is a high possibility that the gaze is not being recognized correctly due to reflections from the lenses. The recognition accuracy determiner 142 may also determine that the recognition accuracy of the monitoring direction has decreased when at least a part of the area of the driver’s eyes in the image is hidden by a physical object (obstacle) such as a hand based on an image analysis result for the captured image.

The recognition accuracy determiner 142 may derive the driver’s eye open rate (an index value indicating the degree to which the eyes are open) based on the results of image analysis of the captured image, and may determine that the recognition accuracy of the monitoring direction has decreased when the derived eye open rate is less than a threshold. For example, the recognition accuracy determiner 142 detects an eye outline by fitting an eye curve model to an edge distribution obtained as an image analysis result. Subsequently, the recognition accuracy determiner 142 calculates a vertical (longitudinal) distance (an inter-feature-point distance) between the topmost and bottommost points in the image among a plurality of feature points forming the eye outline, and calculates the eye open rate by dividing the calculated inter-feature-point distance by a preset maximum distance. The maximum distance may be a maximum inter-feature-point distance obtained from a group of captured images captured for a predetermined period of time at the start of driving, or may be a predetermined fixed distance.

The monitoring determiner 144 determines whether or not the driver’s monitoring direction is appropriate, for example, based on the driver’s monitoring direction recognized by the monitoring direction recognizer 124 and a preset monitoring target area.

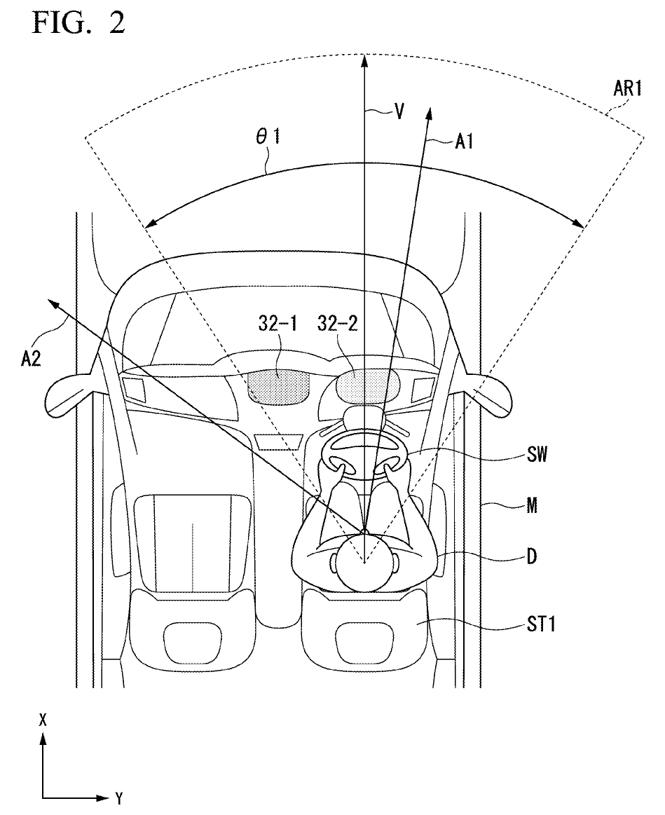

FIG. 2 is a diagram showing a relationship between the driver’s monitoring direction and the monitoring target area. The example of FIG. 2 schematically shows a state in which the driver D sits in the driver’s seat ST1 of the vehicle M and the driver D operates a driving operation element 80 such as the steering wheel SW to perform manual driving for the vehicle M. In the example of FIG. 2, displays 32-1 and 32-2 included in the HMI 30 are shown.

For example, when the vehicle M is traveling in a straight-ahead direction (an X-axis direction in the drawing), the monitoring determiner 144 sets a monitoring target area AR1 having a predetermined angle on the left and right sides from the head position of the driver D based on a travel direction V of the vehicle M as a reference as shown in FIG. 2.

The monitoring target area AR1 may be adjusted based on the speed of the vehicle M, the shape of the road, the recognition result of the recognizer 120, and the like. In this case, the monitoring determiner 144, for example, decreases an angle (radius) θ1 indicating a size of the arc of the monitoring target area AR1 in accordance with a magnitude of a speed or increases the angle θ1 as the width of a road increases.

The monitoring determiner 144 may adjust the monitoring target area AR1 based on the behavior of the vehicle M recognized by the behavior recognizer 126. For example, the behavior recognizer 126 rotates and moves the current monitoring target area AR1 to the right around the position of the driver D’s head when the vehicle M makes a lane change from the travel lane to the adjacent lane on the right, and rotates and moves the current monitoring target area AR1 to the left around the position of the driver D’s head when the vehicle M makes a lane change from the travel lane to the adjacent lane on the left. In this case, the monitoring determiner 144 may change the size of the angle θ1 in addition to (or instead of) the rotational movement. The monitoring determination unit 144 may also rotate the monitoring target area AR1 or change the magnitude of the angle θ1 in accordance with the steering angle, steering amount, and the like of the vehicle M, even when a lane change or a right/left turn is performed by manual driving. When the surrounding environment recognizer 122 recognizes an obstacle (e.g., an obstacle on the road) around the vehicle M, the monitoring determiner 144 may change the magnitude of the angle θ1 so that the obstacle is included.

For example, in the situation shown in FIG. 2, the monitoring determiner 144 determines that the monitoring direction of the driver D is appropriate when the monitoring direction of the driver D recognized by the monitoring direction recognizer 124 is within the angle θ1 of the monitoring target area AR1 (or when a state in which the monitoring direction is within the angle θ1 continues for a predetermined time or more). The monitoring determiner 144 determines that the monitoring direction of the driver D is inappropriate when the monitoring direction is not within the angle θ1 (or when a state in which the monitoring direction is not within the angle θ1 continues for a predetermined time or more). In the example shown in FIG. 2, the monitoring determiner 144 determines that the driver D’s monitoring direction is appropriate when the monitoring direction is an arrow A1, and determines that the driver D’s monitoring direction is inappropriate when the monitoring direction is an arrow A2.

Instead of (or in addition to) determining whether or not the driver D’s monitoring direction is appropriate, the monitoring determiner 144 may determine whether or not the driver D is distracted. In this case, the monitoring determiner 144 determines that the driver D is not distracted when the monitoring direction is the arrow A1 and determines that the driver D is distracted when the monitoring direction is the arrow A2.

### Notification control

Next, content of the notification control in the embodiment will be described. The HMI controller 160 controls the notification for the driver D in accordance with the determination result of the monitoring determiner 144. For example, when the monitoring determiner 144 determines that the monitoring direction of the driver D is inappropriate, as an example of a notification condition, the HMI controller 160 generates notification information about distraction (distraction notification information) and causes the HMI 30 to output the generated distraction notification information to notify the driver D thereof. The distraction notification information may be information indicating that the monitoring direction of the driver D is inappropriate (or that the driver D is distracted), or may be information for prompting the driver D to turn to the correct monitoring direction. The distraction notification information may include, for example, an image indicating the monitoring direction of the driver D or an image indicating the monitoring target area AR1, as shown in FIG. 2. Thereby, the driver D is able to more accurately ascertain that the monitoring direction is inappropriate and a direction in which monitoring should be performed. The distraction notification information may be an image, a sound (e.g., a predetermined notification sound), or both.

When the monitoring determiner 144 determines that the monitoring direction of driver D is appropriate during the notification of distraction notification information, the HMI controller 160 ends the notification (wherein the end can also be referred to as stopping or cancellation). The counter 162 may perform a counting process for the time from the start of the notification, and may not end the notification until a predetermined time has elapsed from the start of the notification (until the count value is greater than or equal to a threshold), even if the monitoring determiner 144 determines that the monitoring direction of the driver D is appropriate during the notification. Thereby, it is possible to suppress the end of the notification in a state in which the driver D has not ascertained the notification content.

The HMI controller 160 facilitates the end of the notification when the recognition accuracy determiner 142 determines that the recognition accuracy of the monitoring direction of the driver D has decreased during the notification of distraction notification information. Thus, even if the recognition accuracy of the monitoring direction recognizer 124 decreases during the notification of the distraction notification information and the monitoring determiner 144 cannot determine whether or not the monitoring direction is appropriate, it is possible to suppress an increase in the notification time.

For example, when it is determined that the recognition accuracy of the monitoring direction of the driver D has decreased, the HMI controller 160 ends the notification regardless of a result of determining whether or not the monitoring direction of the driver D is appropriate in the monitoring determiner 144. Thereby, it is possible to suppress an increase in the notification time when it is not possible to determine whether or not the monitoring direction is appropriate in the monitoring determiner 144.

In an embodiment, when the monitoring direction recognizer 124 determines that the monitoring direction of the driver D, recognized based on at least the driver D’s gaze, is inappropriate and the recognition accuracy of the monitoring direction of the driver D has decreased during the notification by the HMI controller 160, the monitoring determiner 144 may determine whether or not the driver’s monitoring direction is appropriate based on the monitoring direction recognized based on the driver D’s face orientation, without using the driver D’s gaze. Thereby, because it is possible to determine whether or not the monitoring direction is appropriate using only the face orientation, which is easier to recognize than the gaze, a determination result can be more easily obtained. For this reason, it is possible to suppress an increase in the notification time due to an inability to make a determination.

The HMI controller 160 may facilitate the end of the notification only when the recognition accuracy of the monitoring direction by the monitoring direction recognizer 124 has decreased during the notification in the case where the notification for the driver D has started after the monitoring determiner 144 determines that the monitoring direction recognized based on at least the face orientation of the driver D by the monitoring direction recognizer 124 is inappropriate. Thereby, for example, when it is determined that a monitoring direction not associated with the face orientation (or a monitoring direction recognized only from the gaze) is inappropriate, the monitoring direction is not determined to be appropriate even if the face is turned toward the monitoring target area AR1 and it is possible to suppress an increase in the notification time.

The HMI controller 160 may end the notification when the counter 162 performs a counting process for a period of time in which it is determined that the monitoring direction is appropriate when the monitoring determiner 144 determines that the driver’s monitoring direction is an appropriate monitoring direction during the notification of the distraction notification information and when the monitoring direction continues for a predetermined time or more (when the count value is greater than or equal to a threshold). Thereby, it is possible to end the notification in a state in which the driver D is able to monitor the monitoring target area AR1 more reliably. The HMI controller 160 may continue the counting process if the monitoring direction recognized based on only the face orientation of the driver D is an appropriate monitoring direction when the recognition accuracy determiner 142 determines that the recognition accuracy of the monitoring direction of the driver D has decreased during the counting process after it is determined that the monitoring direction recognized based on driver D’s gaze and face orientation is an appropriate monitoring direction. Thereby, because it is possible to easily end the notification even if the recognition accuracy of the monitoring direction decreases during the counting process, it is possible to suppress an increase in the notification time.

If the recognition accuracy of the monitoring direction in the monitoring direction recognizer 124 decreases during the notification, the monitoring determiner 144 may increase the monitoring target area AR1. In this case, the monitoring determiner 144, for example, sets the angle θ1, which indicates the size of the arc of the monitoring target area AR1, to 360 degrees. Thereby, even if the recognition accuracy decreases and the correct monitoring direction cannot be recognized, the monitoring determiner 144 determines that the monitoring direction is appropriate and the notification can easily end as a result.

### Processing flow

Hereinafter, a process executed by the driving assistance device 100 of the embodiment will be described. Hereinafter, a notification process based on a monitoring direction of the driver among processes executed by the driving assistance device 100 will be mainly described.

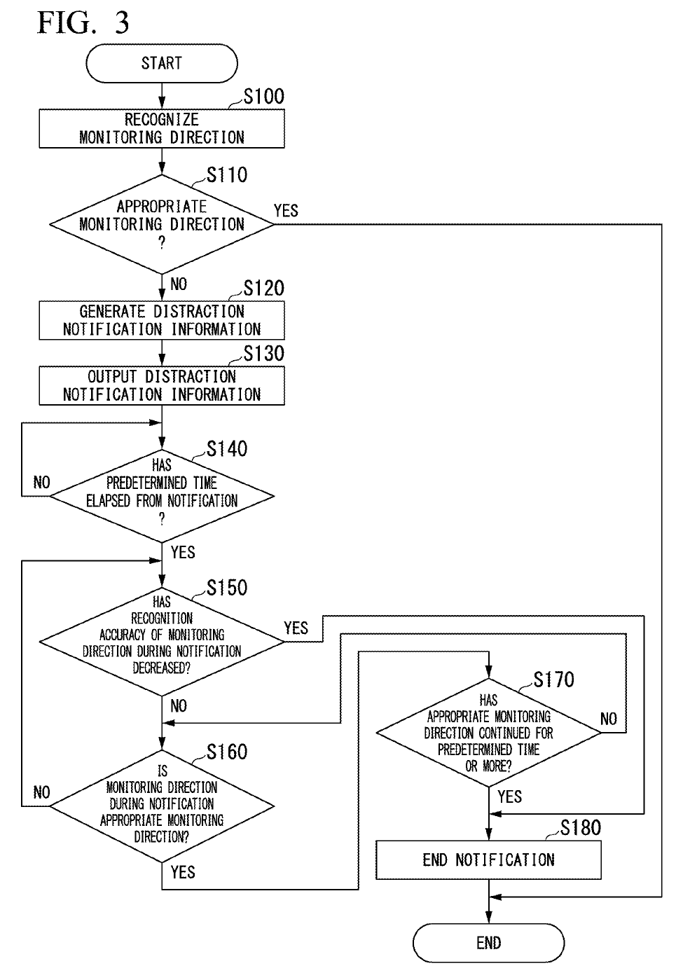

FIG. 3 is a flowchart showing an example of the process executed by the driving assistance device 100 of the embodiment. In the example of FIG. 3, the monitoring direction recognizer 124 recognizes the monitoring direction of the driver of the vehicle M (step S100). Subsequently, the monitoring determiner 144 determines whether or not the driver’s monitoring direction is appropriate (step S110). When it is determined that the monitoring direction is inappropriate, the HMI controller 160 generates distraction notification information (step S120) and causes the HMI 30 to output the generated distraction notification information to notify the driver thereof (step S130).

Subsequently, the HMI controller 160 determines whether or not a predetermined time has elapsed from the notification for the driver based on a time counting result of the counter 162 after the start of the notification (step S140). When it is determined that the predetermined time has not elapsed, the output (notification) of the distraction notification information continues. When it is determined that the predetermined time has elapsed from the notification, the recognition accuracy determiner 142 determines whether or not the recognition accuracy of the driver’s monitoring direction during the notification has decreased (step S150). When it is determined that the recognition accuracy of the monitoring direction has not decreased, the monitoring determiner 144 determines whether or not the driver’s monitoring direction during the notification is an appropriate monitoring direction (step S160). When it is determined that the monitoring direction is inappropriate, the notification continues and the process returns to step S150.

When it is determined that the monitoring direction during the notification is an appropriate monitoring direction in the processing of step S160, the HMI controller 160 determines whether or not a state in which the driver’s monitoring direction is an appropriate monitoring direction has continued for a predetermined period of time or more, based on a time counting result of the counter 162 since the monitoring direction became appropriate (step S170). When it is determined that the state has not continued for the predetermined period of time or more, the process returns to step S160. When it is determined that the state has continued for the predetermined period of time or more, the HMI controller 160 ends the notification (step S180).

When it is determined that the recognition accuracy of the monitoring direction during notification has decreased in the processing of step S150, the HMI controller 160 facilitates the end of the notification in execution. In the example of FIG. 3, the notification ends without executing a process for determining whether or not the driver’s monitoring direction is appropriate (the processing of step S160) or a process for determining whether or not the state of the appropriate monitoring direction has continued for the predetermined time or more (the processing of step S170). Thereby, the process of the present flowchart ends.

When it is determined that the driver’s monitoring direction is appropriate in the processing of step S110, the process of the present flowchart ends. When it is determined that the recognition accuracy of the monitoring direction during notification has decreased in the processing of step S150, one of steps S160 and S170 may be omitted. Even in this case, as a result, the end of the notification in execution is facilitated.

### Modification example

In the embodiment, the HMI controller 160 may generate information indicating a decrease in the recognition accuracy of the driver’s monitoring direction, information indicating the reason for the decrease in the recognition accuracy, information indicating that the end of the notification is facilitated due to the decrease in recognition accuracy, and the like and cause the HMI 30 to output the information. Thereby, it is possible to allow the driver and the like to more accurately ascertain the situation of the notification control regarding the monitoring direction (distraction). Even if the notification ends in a situation in which the driver’s monitoring direction is not yet appropriate, it is possible to suppress giving an uncomfortable feeling to the driver.

In the embodiment, when the HMI controller 160 determines that the driver’s monitoring direction recognized by the monitoring direction recognizer 124 is not an appropriate monitoring direction, information (arrow image) for guiding the driver so that his or her monitoring direction is within the monitoring target area AR1 may be generated and output to the display 32.

In the embodiment, when the gaze of the driver can be recognized, the monitoring direction recognizer 124 recognizes the monitoring direction by giving priority to the gaze over the face orientation, and the monitoring direction may be recognized using the face orientation to facilitate the end of a notification in a situation in which a notification of distraction notification information is provided.

In the embodiment, the travel controller 180 may end the driving control in execution when the recognition accuracy determiner 142 determines that the recognition accuracy of the driver’s monitoring direction has decreased while driving control is being executed. Thereby, it is possible to suppress a process for executing erroneous driving control when a monitoring direction different from the driver’s actual monitoring direction is recognized due to a decrease in recognition accuracy. When it is determined that the recognition accuracy of the driver’s monitoring direction has decreased during the notification of distraction notification information and during the execution of driving control, the HMI controller 160 may facilitate the end of the notification after the end of the driving control in execution.

According to the embodiment described above, a notification control device includes the monitoring direction recognizer 124 configured to recognize a monitoring direction of a driver of the vehicle M (an example of a mobile object); the determiner 140 configured to determine whether or not the monitoring direction recognized by the monitoring direction recognizer 124 is appropriate; and a notification controller (the HMI 30 and the HMI controller 160) configured to control a notification for the driver in accordance with a determination result of the determiner 140, wherein the notification controller facilitates an end of the notification when recognition accuracy of the monitoring direction in the monitoring direction recognizer 124 decreases during the notification, whereby it is possible to more appropriately provide a notification for the driver.

For example, according to the embodiment, when the driver’s gaze cannot be recognized based on the captured image due to the effects of external disturbance light or the like, and the recognition accuracy of the monitoring direction decreases, it is possible to end the notification more easily by recognizing the monitoring direction based on only the driver’s face orientation. According to the embodiment, during the notification of the distraction notification information, even if the monitoring direction recognized using the gaze and the face orientation is an appropriate monitoring direction and the recognition accuracy decreases due to external disturbances and the like during the counting process until this state continues for a predetermined time or more, the counting process continues (without resetting midway) when it is determined that the monitoring direction based on the face orientation is appropriate. Thereby, it is possible to suppress an increase in the notification time due to the inaccurate determination caused by a decrease in recognition accuracy.

The embodiment described above can be represented as follows.

A notification control device including:

a storage medium storing computer-readable instructions; and

a processor connected to the storage medium, the processor executing the computer-readable instructions to:

recognize a monitoring direction of a driver of a mobile object;

determine whether or not the recognized monitoring direction is appropriate;

control a notification for the driver in accordance with a determination result; and

facilitate an end of the notification when recognition accuracy of the monitoring direction decreases during the notification.

Although modes for carrying out the present invention have been described using embodiments, the present invention is not limited to the embodiments and various modifications and substitutions can also be made without departing from the scope and spirit of the present invention.

What is claimed is:

1. A notification control device comprising:
a monitoring direction recognizer configured to recognize a monitoring direction of a driver of a mobile object;
a determiner configured to determine whether or not the monitoring direction recognized by the monitoring direction recognizer is appropriate; and
a notification controller configured to control a notification for the driver in accordance with a determination result of the determiner,
wherein the notification controller facilitates an end of the notification when recognition accuracy of the monitoring direction in the monitoring direction recognizer decreases during the notification.

2. The notification control device according to claim 1, wherein the notification controller ends the notification regardless of a result of determining whether or not the monitoring direction is appropriate in the determiner when the recognition accuracy of the monitoring direction decreases during the notification.

3. The notification control device according to claim 1,
wherein the monitoring direction recognizer recognizes the monitoring direction using at least one of eye movement and face movement of the driver, and
wherein, when it is determined that the monitoring direction of the driver recognized based on at least the eye movement by the monitoring direction recognizer is inappropriate and the recognition accuracy of the monitoring direction decreases during the notification by the notification controller, the determiner determines whether or not the monitoring direction of the driver is appropriate according to the monitoring direction recognized based on the face movement of the driver without using the eye movement.

4. The notification control device according to claim 1,
wherein the notification controller starts the notification for the driver when the determiner determines that the monitoring direction recognized based on at least the face movement of the driver by the monitoring direction recognizer is inappropriate, and
wherein the notification controller facilitates the end of the notification when the recognition accuracy of the monitoring direction in the monitoring direction recognizer decreases during the notification.

5. The notification control device according to claim 1,
wherein the notification controller performs a counting process for a period of time in which it is determined that the monitoring direction is appropriate when the determiner determines that the monitoring direction of the driver is an appropriate monitoring direction during the notification and ends the notification when the appropriate monitoring direction continues for a predetermined time or more, and
wherein the notification controller continues the counting process when it is determined that the recognition accuracy of the monitoring direction of the driver decreases while the period of time in which it is determined that the monitoring direction recognized based on the eye movement and the face movement of the driver is an appropriate monitoring direction is counted and when it is determined that the monitoring direction recognized based on a face orientation of the driver is an appropriate monitoring direction.

6. A notification control method comprising:
recognizing, by a computer, a monitoring direction of a driver of a mobile object;
determining, by the computer, whether or not the recognized monitoring direction is appropriate;
controlling, by the computer, a notification for the driver in accordance with a determination result; and
facilitating, by the computer, an end of the notification when recognition accuracy of the monitoring direction decreases during the notification.

7. A computer-readable non-transitory storage medium storing a program for causing a computer to:
recognize a monitoring direction of a driver of a mobile object;
determine whether or not the recognized monitoring direction is appropriate;
control a notification for the driver in accordance with a determination result; and
facilitate an end of the notification when recognition accuracy of the monitoring direction decreases during the notification.
